(19) United States
(12) Patent Application Publication
(10) Pub. No.: US 2022/0020113 A1
(43) Pub. Date: Jan. 20, 2022

(54) IMAGE RESIZING USING SEAM CARVING

(71) Applicant: Instasize, Inc., Sandy, UT (US)

(72) Inventors: Luca Meschiari, Miami, FL (US); Peter Majewicz, Boise, ID (US); Rekil Prashanth, Mesa, AZ (US)

(21) Appl. No.: 17/376,153

(22) Filed: Jul. 14, 2021

Related U.S. Application Data
(60) Provisional application No. 63/052,394, filed on Jul. 15, 2020.

(51) Int. Cl. G06T 3/40; G06K 9/00; G06T 7/13

(52) U.S. Cl. CPC G06T 3/403; G06T 7/13; G06K 9/00624

(57) ABSTRACT

An example method presents a system for improved image resizing using seam carving. The system may receive a digital image file of an image and determine a target aspect ratio of the image. The system may compute a mask identifying objects in the image, determine a path of pixels extending between a first edge of the image and a second edge of the image using the mask, and remove the path of pixels from the image to generate an edited image. In some instances, the system may output the edited image with a different aspect ratio than the received image using the removed path of pixels. In some instances, the system may process the image from 2, 4, or 8 directions, for example, to balance proportionate amounts of resizing when adjusting the aspect ratio of the image.

### BACKGROUND

The present specification generally relates to a technology for resizing images, which may change their aspect ratios. For instance, the technology describes improvements to seam carving.

Images are often resized or cropped when used on websites, social media, video, or otherwise; however, previous methods of resizing images had numerous problems. For instance, traditional methods of resizing an image or changing its aspect ratio, such as merely cropping the exterior edges from an image or stretching the image, may remove desirable objects from images or distort the objects. For instance, merely cropping an image may remove objects from the edge of an image while compressing or stretching an image may distort objects in the image.

Previously, it has been proposed to use seam carving to remove seams from images; however, these traditional methods also had problems that made them undesirable for use. For instance, Rubinstein, Michael et al. “Improved seam carving for video retargeting.” SIGGRAPH 2008 (2008), describes determining forward energy. Another example of seam carving is provided in Avidan, S. and Ariel Shamir. “Seam carving for content-aware image resizing.” ACM SIGGRAPH 2007 papers (2007). However, both of these references result in unbalanced, distorted, and inefficient results. For example, previous solutions for seam carving resized an image in only one direction, resized or otherwise caused distortion to objects in an image, and were heavily processor intensive, so they were not efficiently executed locally on a client computing device. Further, some previous research indicated that seam carving is the worst of retargeting or resizing algorithms due to these problems.

Accordingly, the technology described herein resizes image, for example, by improving the efficiency, accuracy, and usability of seam carving, among other improvements, such as to the resulting resized image.

### SUMMARY

An improved image resizing using seam carving system can be configured to perform particular operations or actions by virtue of having software, firmware, hardware, or a combination of them installed on the system that in operation causes or cause the system to perform the actions. One general aspect of the system includes a method that includes: receiving a digital image file of an image; determining a target aspect ratio for the image; computing one or more masks identifying one or more objects in the image; determining a first path of pixels extending between a first edge of the image and a second edge of the image using the one or more masks, the first edge opposing the second edge; removing the first path of pixels from the image to generate an edited image; and outputting the edited image, the edited image having a different aspect ratio than the received image.

Some embodiments may include one or more of the following features: that determining the first path of pixels includes determining the first path of pixels from a first starting pixel on the first edge, the first path of pixels having fewer than a threshold quantity of interactions with the one or more objects in the image based on the one or more masks; determining a quantity of interactions of the first path with the one or more objects based on each time the first path of pixels intersects with the one or more objects identified by the one or more masks, the threshold quantity of interactions being a percentage of a distance between the first edge and the second edge in pixels; determining a second starting pixel on the first edge for a second path of pixels, determining a quantity of interactions of the second path with the one or more objects, and in response to determining that the quantity of interactions of the second path satisfy the threshold quantity of interactions with the one or more objects, stopping determination of the second path of pixels and determining the first starting pixel for the first path of pixels.

Some embodiments may additionally or alternatively include one or more of the following features: determining, by one or more processors, a first starting pixel on the first edge based on the first starting pixel having a least accumulated directional activity, the first starting pixel being a first pixel on the first path of pixels; determining a second path of pixels between a third edge of the image and a fourth edge of the image using the one or more masks, the third edge opposing the fourth edge, the third edge being perpendicular to the first edge, and adding pixels along the second path; and removing, by one or more processors, the one or more first paths of pixels extending between the first edge and the second edge and adding the one or more second paths of pixels extending between the third edge and the fourth edge until a target aspect ratio is achieved, the one or more first paths including the first path, the one or more second paths including the second path.

Some embodiments may additionally or alternatively include one or more of the following features: determining a first resize amount along a first direction based on one or more activity maps, the first direction extending between a third edge of the image and a fourth edge of the image, the third edge opposing and parallel with the fourth edge, the third edge being perpendicular to the first edge, the first resize amount reducing a quantity of pixels of the image along the first direction, and determining a second resize amount along a second direction based on the one or more activity maps, the second direction extending between the first edge of the image and the second edge of the image, the second resize amount increasing a quantity of pixels of the image along the second direction; computing a directional activity map in each of four directions for the image, the four directions including the first direction from the third edge to the fourth edge, the second direction from the first edge to the second edge, a third direction from the fourth edge to the third edge, and a fourth direction from the second edge to the first edge, the one or more activity maps including the directional activity maps in the four directions, determining a directional activity level across the image for each of the four directions, and determining a proportion of the first resize amount to the second resize amount based on ratios of the directional activity levels; determining that the first resize amount has not been met during resizing of the image in the first direction, recording a difference between an achieved resize amount in the first direction and the first resize amount, and determining a remainder based on the difference between the achieved resize amount in the first direction; adjusting the second resize amount based on the remainder so that additional pixels are added in the second direction; and adjusting a third resize amount based on the remainder so that additional pixels are removed in a third direction, the third direction opposing and parallel with the first direction.

Some embodiments may additionally or alternatively include one or more of the following features: setting the image to a first orientation in which a width of the image is greater than a height of the image, the first edge of the image being located at top of the image in the first orientation, removing the first path of pixels from the image, rotating the image ninety degrees to a second orientation, adding a second path of pixels to the image, the second path of pixels extending between a third edge of the image and a fourth edge of the image, the third edge opposing the fourth edge, the third edge being perpendicular to the first edge, rotating the image ninety degrees to a third orientation, removing a third path of pixels from the image, the third path of pixels extending between the second edge of the image and the first edge of the image, rotating the image ninety degrees to a fourth orientation, and adding a fourth path of pixels to the image, the fourth path of pixels extending between the fourth edge of the image and the third edge of the image; determining, by one or more processors, that a target aspect ratio has not been achieved, reducing, by one or more processors, a processing requirement for adding pixels to the image or removing pixels from the image based on the determination that the target aspect ratio has not been achieved, rotating, by one or more processors, the image at least once to at least one of the first orientation and the third orientation, removing, by one or more processors, a fifth path of pixels from the image, and setting, by one or more processors, the image to an original orientation in which the image was received; and rotating, by one or more processors, the image at least once to at least one of the second orientation and the fourth orientation, and adding, by one or more processors, a sixth path of pixels to the image.

Some embodiments may additionally or alternatively include one or more of the following features: that computing the one or more masks includes generating a binary mask using a feature map and a background-foreground pixel map; removing clusters of pixels from the one or more masks based on the clusters having fewer than a defined quantity of pixels; that a starting pixel of the first path of pixels is located at the first edge of the image, and the starting pixel of the first path of pixels is not located at a corner of the image; and that determining the starting pixel includes generating a bias map based on the one or more masks, generating an activity map, multiplying the activity map with the bias map at each pixel to create a modified activity map, searching a row of the modified activity map to determine a pixel with a least accumulated directional activity, and setting the determined pixel as the starting pixel.

Other embodiments of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The patent or application file contains at least one drawing executed in color. Copies of this patent or patent publication with color drawing(s) will be provided by the Office upon request and payment of the necessary fee.

The disclosure is illustrated by way of example, and not by way of limitation in the figures of the accompanying drawings in which like reference numerals are used to refer to similar elements.

FIG. 1A illustrates an example method for generating an edited image using a received image.

FIG. 1B illustrates an example method for resizing an image using improved seam carving operations.

FIGS. 2A-2D illustrate example detailed methods for resizing an image using improved seam carving.

FIGS. 3A-3C illustrate example images and resizing thereof

FIGS. 4A-4C illustrate example images and resizing thereof using various directional processing levels.

FIGS. 5A-5C illustrate example object, edge, and combined maps describing an image.

FIG. 6 illustrates an example computing device.

### DESCRIPTION

The present specification generally relates to a technology for resizing images. For instance, the technology describes improvements to seam carving, which may allow an image to be resized by removing pixels or seams of pixels from areas of an image with little contrast, texture, or with few objects. The technology may allow interior portions of an image to be removed when resizing image while avoiding distortion of objects in the image. Although it is not required to change the aspect ratio of the image, in some instances, the resizing described herein may be used to change the aspect ratio of the image.

The technology described herein provides a number of improvements described throughout this specification over, for example, the previous solutions described in the background section. In some implementations, the technology may resize an image by removing seams of pixels or adding seams of pixels to images thereby resizing them from multiple directions. For instance, the technology may rotate the image and/or process it from each edge to iteratively add/subtract pixels thereby resizing the image from an original aspect ratio to a target aspect ratio. The technology allows seams to be efficiently removed from an image, for example, in such a way that the processing may be performed on a mobile device with limited processing and/or bandwidth capabilities. The technology described herein also improves the accuracy and usability of seam carving or image resizing, as described herein.

The technology described herein may change the aspect ratio of an image, for example, from a rectangle to a square. The technology may do this in a manner that may selectively remove or expand low-contrast bands and may minimally affect the visually important objects and textures in the image. For instance, implementations of the technology do not crop an image, but rather carry the significant information forward into a natural-looking image. In some implementations, the technology may terminate early without hitting the target aspect ratio (e.g., square) if the result image would be too distorted or not natural looking.

As described throughout this disclosure, the technology may use a 4 to 8 stage process, bias map weighting, identification of space between objects in a mask, determined resize ratios, object hits, forward passing of unachieved resize amounts, and early stopping of processing to make the algorithms robust and efficient enough for a simple mobile application, for example, for a smartphone with limited screen size and processing capabilities.

The features and advantages described herein are not all-inclusive and many additional features and advantages will be apparent to a person of ordinary skill in the art in view of the figures and description. Also, it should be noted that the language used in the specification has been selected for readability and instructional purposes and not to limit the scope of the inventive subject matter.

With reference to the Figures, reference numbers may be used to refer to components found in any of the figures, regardless whether those reference numbers are shown in the Figures being described. Further, where a reference number includes a letter referring to one of multiple similar components (e.g., component 000a, 000b, and 000n), the reference number may be used without the letter to refer to one or all of the similar components.

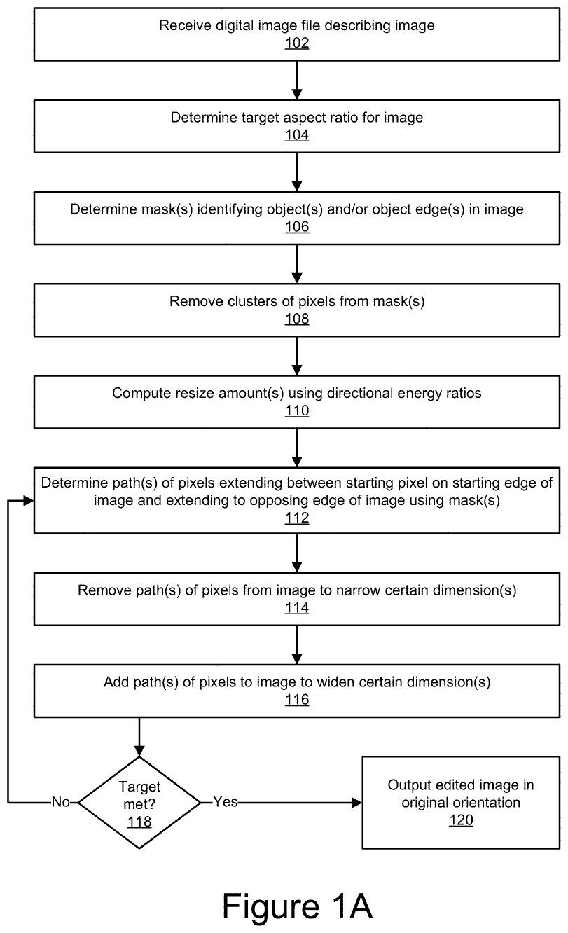

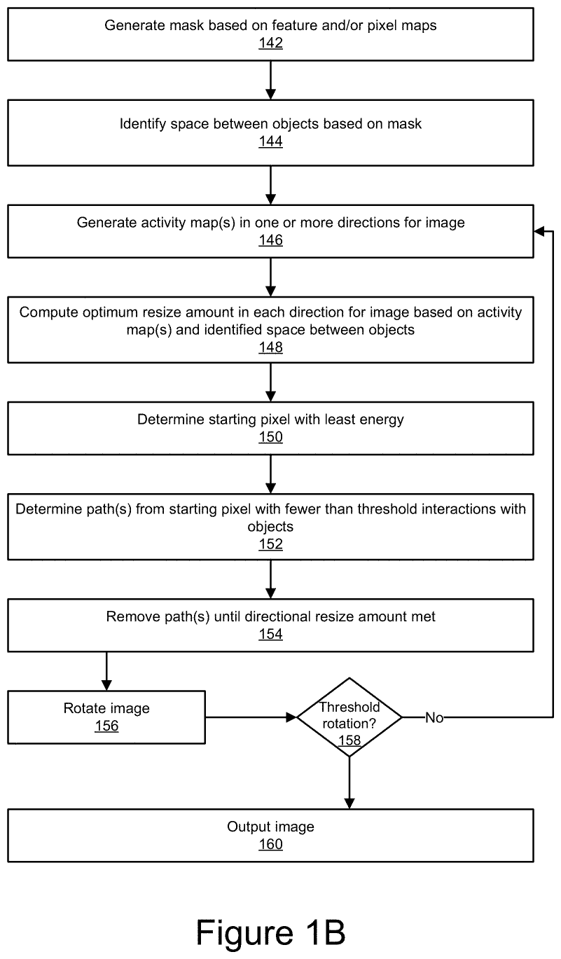

FIG. 1A illustrates an example method for generating an edited image using a received image. For example, in certain social networks, websites, web stories, messaging applications, or mobile applications an image may be best displayed in a certain aspect ratio (or such may be required by the application). The example method described in FIG. 1A receives an image in an original aspect ratio and intelligently adjusts the image to an output aspect ratio. In some implementations, this may be done without cropping external edges from the image, for example, by removing low-contrast or unimportant areas of an image.

At 102, the seam carving application 622 may receive a digital image file describing an image. The file may be captured by an onboard or communicatively coupled camera, received from another device (e.g., via an application programming interface), or may be retrieved from file storage. In some implementations, the seam carving application 622 may detect an original orientation and/or aspect ratio of the received image and determine whether it should be resized and/or certain operations (such as those described herein) should be used to adjust the size, resolution, and/or aspect ratio of the image. The image may be grayscale, RGB, or in any file format.

At 104, the seam carving application 622 may determine a target aspect ratio for the image. For example, the target aspect ratio may be received/select by a user via a graphical user interface, automatically determined based on an application in which it may be used (e.g., if the image is being used as a 3:4 or 1:1 image on a social application), or a target aspect ratio may be defined (e.g., by an administrator). For example, if a received image is in a 16:9 aspect ratio, but the user or application requests a 1:1 aspect ratio, the seam carving application 622 may set 1:1 as the target aspect ratio. Additionally or alternatively, the seam carving application 622 may determine an optimum or recommended output aspect ratio based on image analysis and/or a closest achievable aspect ratio (e.g., determined using the operations below) to a requested aspect ratio. For instance, additional details for determining an aspect ratio are described below, such as in reference to operations 110 or 148.

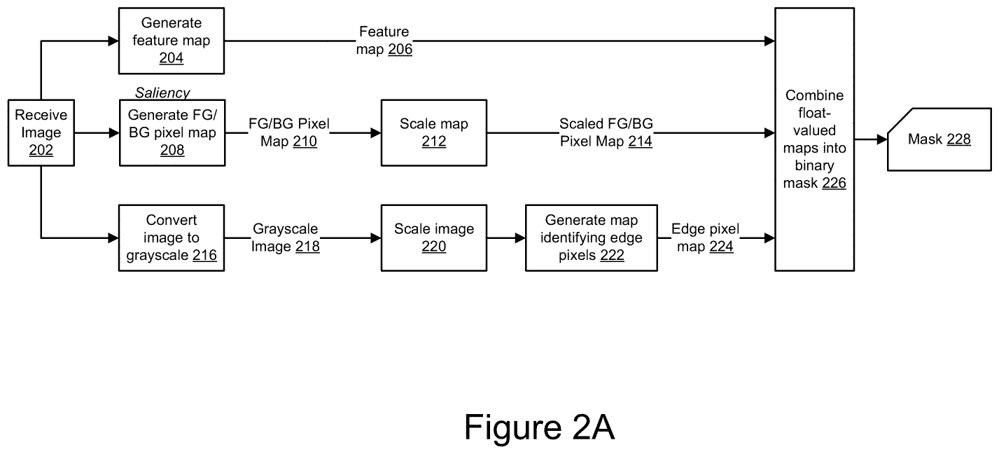

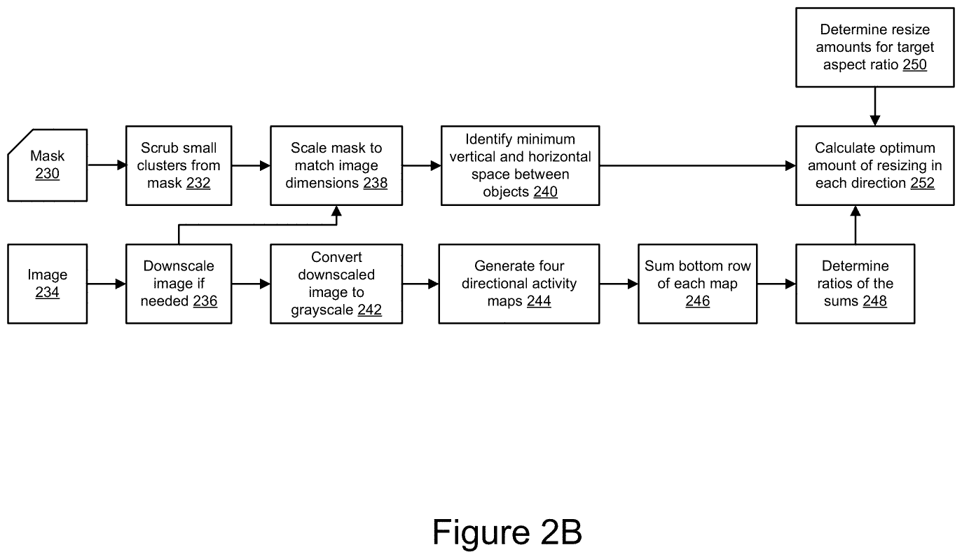

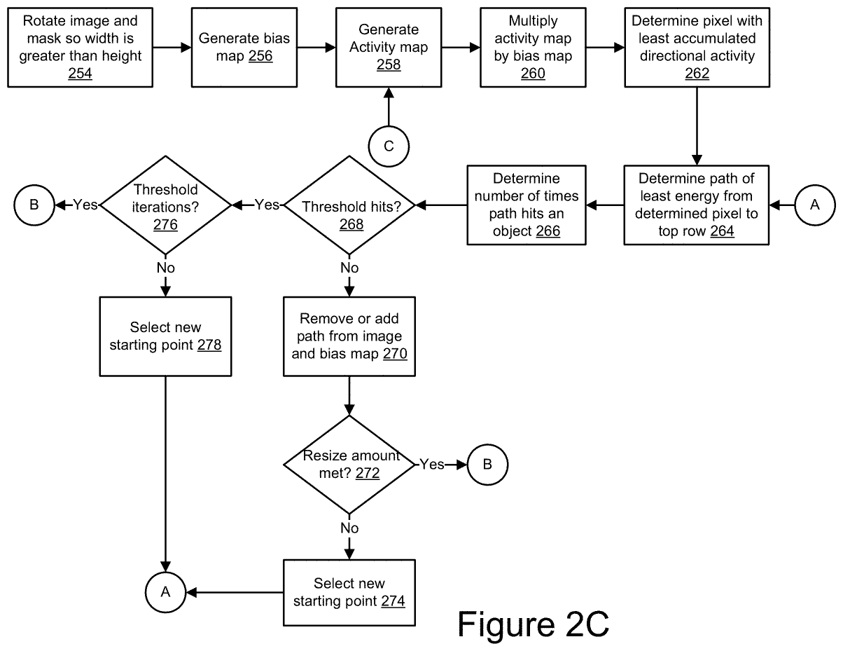

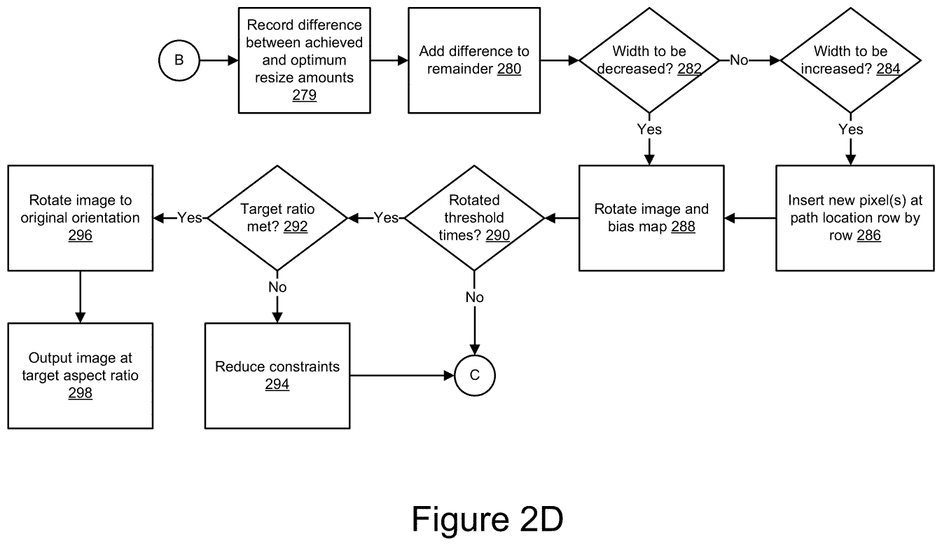

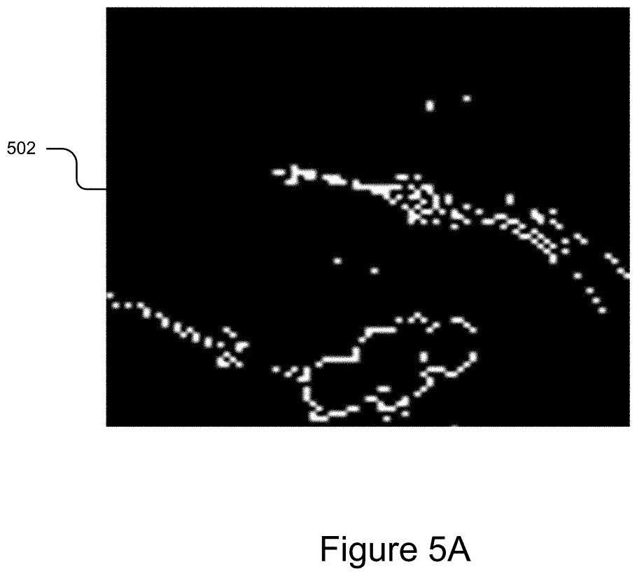

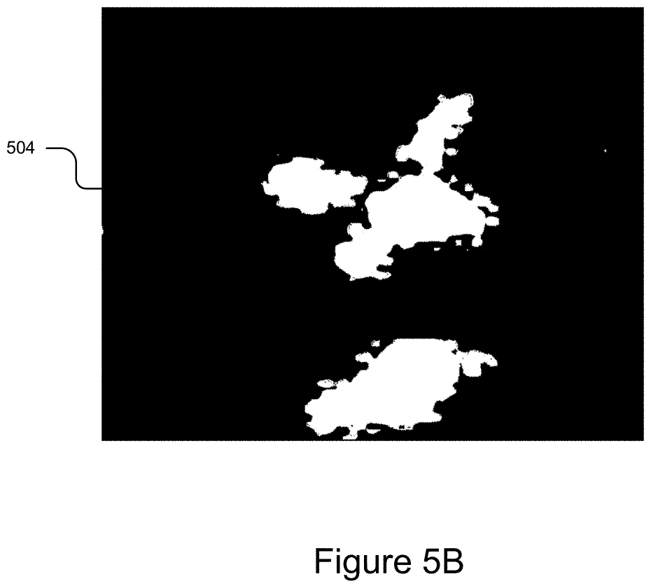

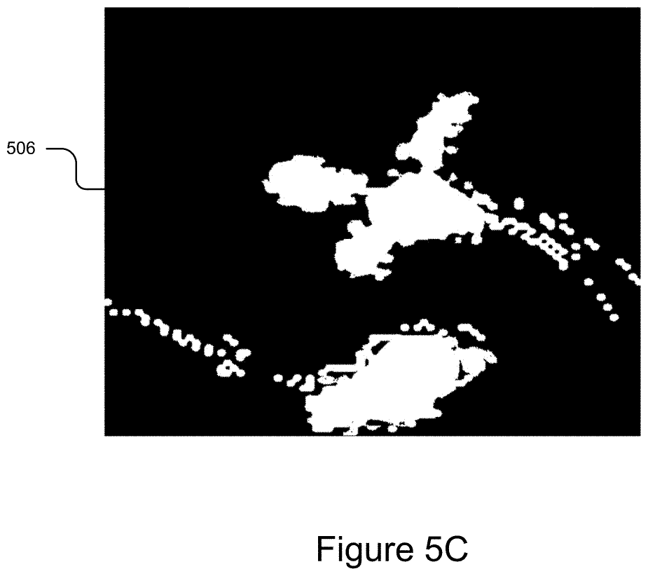

At 106, the seam carving application 622 may determine mask(s) identifying object(s) and or object edge(s) in the image. In some implementations, the seam carving application 622 may compute one or more masks that identify one or more objects in the image. For example, the seam carving application 622 may generate an object and/or edge map or mask, as described in further detail below. In some instances, the mask may distinguish pixels between background and foreground pixels and/or perform additional operations on background/foreground pixels. For instance, the seam carving application 622 may generate a binary or float valued mask using a feature map and a background-foreground pixel map, as described in further detail below. The generation and use of the mask(s) are described in further detail below, for example, in reference to the operation at 142 and FIGS. 2A, 5A, 5B, and 5C.

In some implementations, the seam carving application 622 may remove pixels, add pixels, rotate, or perform other operations on the mask(s) along with the image, so that the mask(s) continue to represent the image and the pixels correspond to one another accurately.

In some implementations, the seam carving application 622 may downscale the mask and/or image or reduce its color space (e.g., by converting it to grayscale) in order to reduce processing requirements and increase computational efficiency. In some instances, once the pixels are selected for addition or removal, the seam carving application 622 may return the image to its original resolution less the removed pixels.

In some implementations, at 108, the seam carving application 622 may remove clusters of pixels from the mask(s). For instance, the seam carving application 622 may remove identify clusters within the mask with fewer than a defined quantity of pixels using various clustering algorithms, for example, as described in further detail below.

At 110, the seam carving application 622 may compute one or more resize amount(s) using directional energy ratios. A resize amount may be an quantity of pixels removed from a certain direction of the image, for example, if an image is to be horizontally resized, the resize amount may indicate the distance (e.g., in percent or quantity of pixels) by which the image is reduced (or increased) horizontally. In some implementations, a rectangular image may have four resize amounts each indicating an amount by which an image may be resized (e.g., by adding or removing pixels), for instance, a resize amount from the right may begin (e.g., determining and removing/adding seams) at a right edge and beginning at a correspond edge and moving toward the left edge. In some implementations, the seam carving application 622 may compute the resize amounts for each direction simultaneously, sequentially, and/or update them at various intervals. For instance, the seam carving application 622 may compute four (or one, two, or three) resize amounts from each edge of an image, perform the resizing (e.g., as described below), and then calculate new resize amounts for the directions for a second round of resizing (e.g., as described in reference to FIG. 2D).

By pre-computing and/or pre-analyzing the image to determine directional resizing proportions, the seam carving application 622 may guide the amount of seams to add or remove in each direction, thereby improving the resized appearance (e.g., so that an image isn't completely resized from one side and image composition remains relatively constant).

The resize amount may additionally or alternatively be based on the difference between a current aspect ratio and the target aspect ratio or it may be based on or constrained by existence and/or locations of objects in the mask and/or image. For instance, the seam carving application 622 may identify a minimum vertical space between objects and a minimum horizontal space between objects.

In some implementations, the seam carving application 622 may determine the resize amount(s) using directional energy or activity, such as determined by activity maps. For instance, the seam carving application 622 may determine a first resize amount along a first direction (e.g., from right to left, left to right, top to bottom, or bottom to top, etc.) based on one or more activity maps. The first resize amount may reduce a quantity of pixels of the image along the first direction, for example, by removing paths or seams of pixels (e.g., removing a one pixel wide path extending between a top and bottom of an image may reduce a horizontal direction of the image by one pixel). The seam carving application 622 may determine a second resize amount along a direction perpendicular to the first. In some instances, depending on the target aspect ratio, while the first resize amount may decrease pixels, the second resize amount may increase pixels (e.g., so an image becomes narrower and taller).

Accordingly, the relative amounts by which an image may be resized in different directions may be balanced and/or biased to proportionately resize the image in certain directions. For instance, if there is more space between objects horizontally than vertically, the seam carving application 622 may bias the resize amounts so that more resizing is done horizontally than vertically, thereby hiding the resize amounts and potentially increasing accuracy and efficiency, depending on the implementation. Accordingly, directions with proportionately lower energy or activity may be carved more.

In some implementations, the seam carving application 622 may estimate optimal resize amounts using energy maps and a ratio of total energy accumulated in each direction to bias resizing activity. For instance, the seam carving application 622 may determine one or more ratios of directional activity maps and determine the resize ratios based on the ratios.

In some implementations, the seam carving application 622 may compute a directional activity map in each of four directions for the image (e.g., from each of four edges). The seam carving application 622 may determine a directional activity level across the image for each direction and, based on ratios of the directional activity levels, determine the proportions of the resize amounts. Further details are described below, for example, in reference to the operations at 148 and 240-252. In some instances, the seam carving application 622 may use remainders to adjust resize amounts in different directions, as described in further detail below.

At 112, the seam carving application 622 may determine path(s) of pixels extending between a starting pixel on a starting edge of the image and extending to opposing edge of the image using the mask(s). For instance, the seam carving application 622 may determine a path of pixels from a starting pixel on an edge of the image.

The starting pixel may be the first pixel of a path and may be located on an edge of the image (e.g., between or not at a corner of the image). In some implementations, the seam carving application 622 may determine a first starting pixel on a first edge based on the first starting pixel having a least accumulated directional activity, for example, based on an activity map or forward energy. For instance, the seam carving application 622 may search a row (e.g., a bottom or other edge row) of an activity map to determine a pixel with a least accumulated directional activity or energy.

For example, the seam carving application 622 may generate a bias map based on the one or more masks, generate an activity map, and multiply the activity map with the bias map at each pixel to create a modified activity map. The seam carving application 622 may then search a row of the modified activity map to determine a pixel with a least (or otherwise below a defined or determined threshold) accumulated directional activity and set the determined pixel as the starting pixel. These and other features are described in further detail below in reference to FIGS. 2A-2D.

Once a starting pixel has been determined, the seam carving application 622 may determine a path of pixels from the starting pixel on a starting edge to a pixel on an opposing edge (e.g., parallel with the first edge) of the image. In some implementations, the path of pixels may be one pixel wide, although it is possible to create a path of multiple pixels.

In some implementations, the path may be a straight line extending completely across the image. In some implementations, the path may be intelligently determined based on aspects of the image, mask(s), map(s), etc. For instance, the seam carving application 622 may determine a path of least energy pixels or those with low contrast, as described in further detail in reference to FIG. 2C.

In some implementations, the seam carving application 622 may automatically stop computation of a path or seam if certain conditions are met. For instance, if the path intersects an object too many times or has too much energy, activity, or contrast, the seam carving application 622 may stop the path (without removing it) and determine a new starting pixel and new path. If there are a threshold number of failures, the seam carving application 622 may record the difference (e.g., from the determined resize amount and/or the target aspect ratio). In some instances, the difference may be used when determining how much to resize by another direction or for other operations or analytics.

The seam carving application 622 may determine paths with fewer than a threshold quantity of interactions with objects, for instance, as indicated by the mask(s) determined above. The threshold quantity may be a percentage of the distance between the first edge and the opposing edge, for example, if a mask (and corresponding image) is 1000 pixels high, the threshold may be 1% (or another defined amount), so the path may interact with fewer than 10 pixels before it is stopped. Accordingly, computational efficiency can be significantly improved or set based on administrative settings or performance requirements.

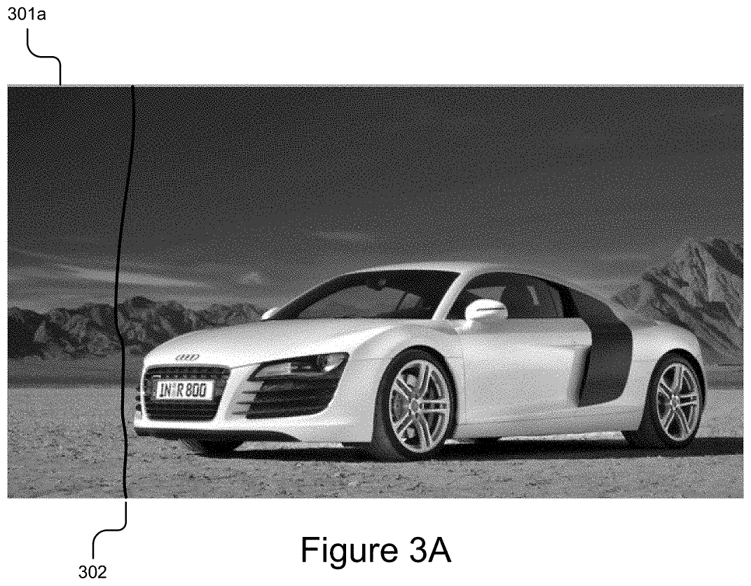

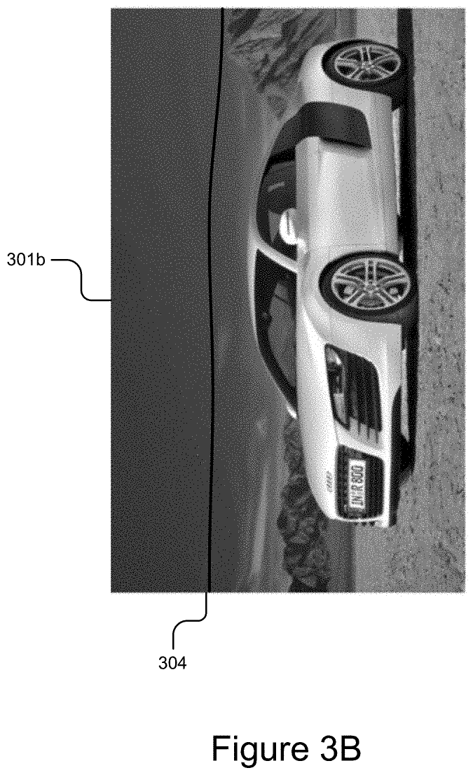

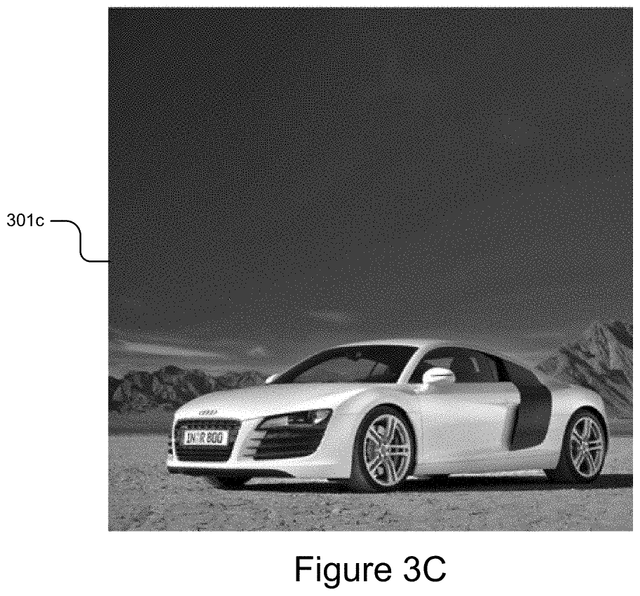

Additional details for determining paths or seams of pixels are described throughout this disclosure, for example, in reference to the operations at 150-150 and FIGS. 2C, 3A, and 3B.

At 114, the seam carving application 622 may remove path(s) of pixels from the image to narrow one or more certain dimension(s) thereby generating an edited image as described in further detail below. In some instances, the seam carving application 622 may additionally remove the same pixels from associated maps or masks, so that they continue to match up with the image.

At 116, the seam carving application 622 may add path(s) of pixels to the image to widen certain dimension(s). For instance, the seam carving application 622 may add paths of pixels to increase a certain dimension of the. For instance, if a 16:9 aspect ratio is received, the seam carving application 622 may remove vertical paths and add horizontal paths to make the image square (e.g., 1:1 aspect ratio). Although paths or seams may be removed or added in any direction, in some implementations, the seam carving application 622 may add or remove only paths that cross the image in one direction, but may rotate the image to allow the paths to be formed from any edge of the image. Although other methods are possible and contemplated herein, the seam carving application 622 may use quadratic interpolation to determine values for newly added pixels. These and other features are further described below, for example, in reference to the operations at 270, 284, and 286.

At 118, the seam carving application 622 may determine whether the target aspect ratio and/or the determined resize amounts were achieved. For instance, if the determined resize amounts and/or the aspect ratio were not met, the seam carving application 622 may remove multiple paths to narrow an image and add multiple paths to make an image taller. In some implementations, if, the image was processed from all directions but the determined resize amounts and/or target aspect ratio were not achieved, the seam carving application 622 may reduce constraints, such as the threshold at which path are stopped, and process the image from one or more direction again, such as described in further detail in reference to FIG. 2D.

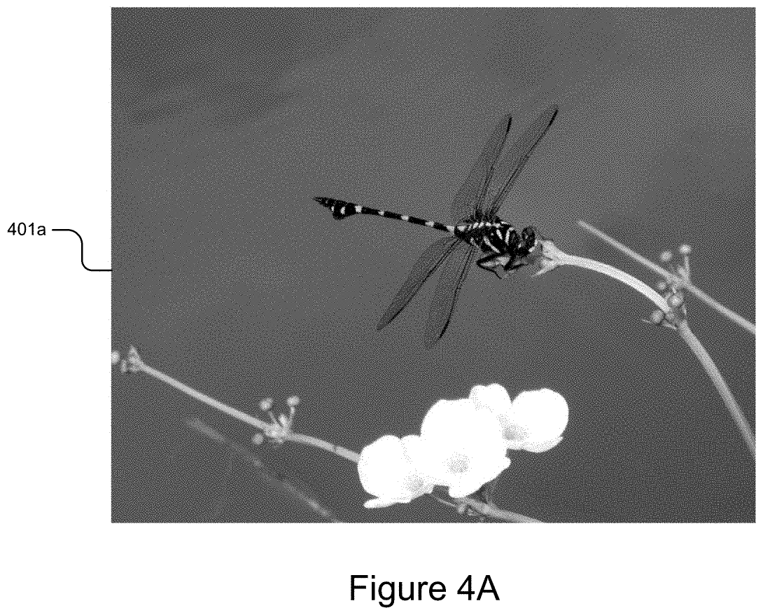

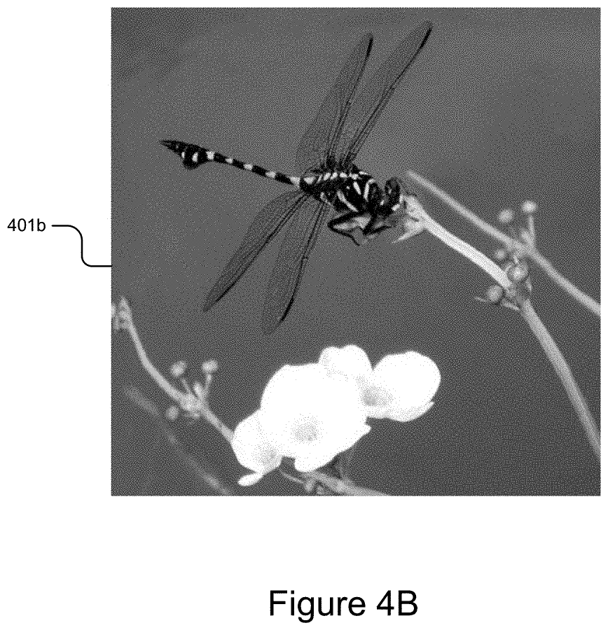

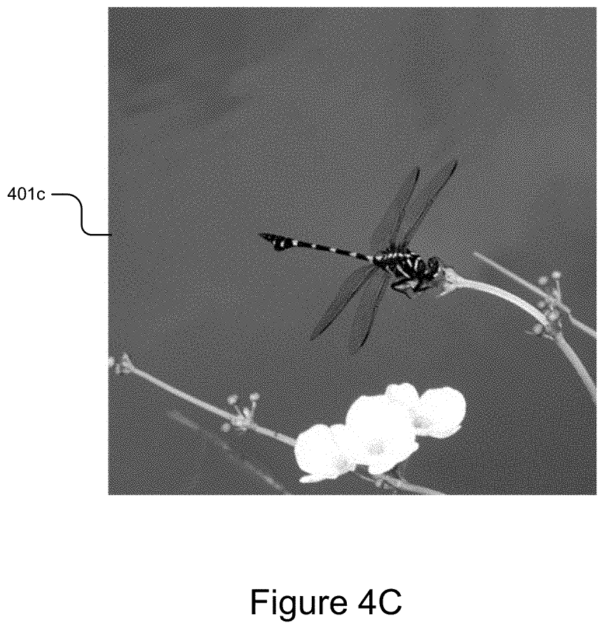

If the target aspect ratio and/or resize amounts were met, the seam carving application 622 may output the edited image in the original orientation at 120. The edited image may have a different aspect ratio than the received image. In some implementations, if the target is not achieved, the seam carving application 622 may output an error message or a notification indicating that it has not been achieved. In such circumstances, the seam carving application 622 may additionally (e.g., in response to user input) perform other operations, such as cropping or stretching the image to achieve the target aspect ratio. For example, FIG. 3A represents an input image and the output image is represented by FIG. 3C. Similarly, FIG. 4A represents an input image while FIG. 4B represents a one-pass result (e.g., where the image has been resized from one direction) and FIG. 4C represents an eight-pass result (e.g., where the image has been resized twice from each of the four directions).

FIG. 1B illustrates an example method for resizing an image. Some implementations of the method provide multi-stage directional resizing where the dimensions of an image are expanded or contracted to achieve a target aspect ratio. In some implementations, a seam carving application 622 may perform pre-analysis of directional energy maps to determine proportions for resizing in each direction (e.g., four directions on the image). The seam carving application 622 may use the directional proportions to guide the number of seams to add or remove in each direction. For example, directions with proportionally lower energy are may be carved more than those with higher energy.

While the example method in FIG. 1B includes similar elements to those described in reference to the other figures and methods described herein, it should be noted that the order and selection of operations may be modified. For instance, operations of each of the methods described herein may be added to one another or interchanged (e.g., an operation described in reference to FIG. 1A or 2A-2D may be used in the method of FIG. 1B).

At 142, the seam carving application 622 may generate a mask based on feature and/or pixel maps. Example operations for generating a mask are described in reference to FIG. 2A.

At 144, the seam carving application 622 may identify a space between objects based on the mask. For instance, identifying the space may include identifying a minimum vertical space between the objects and/or identifying a minimum horizontal space between the objects. The seam carving application 622 may determine available space using directional energy or activity and/or masks, as described below or in reference to FIGS. 1A and 2B.

At 146, the seam carving application 622 may generate activity map(s) in one or multiple directions for the image, for example, as described elsewhere herein.

At 148, the seam carving application 622 may compute a resize amount in each (e.g., multiple) direction for the image based on the activity map(s) and/or identified space between objects. For instance, the seam carving application 622 may determine an optimum resize amount by which an image may be reduced from each direction, for example, from each edge of a rectangular image. In some implementations, the multiple directions include four directions for the image where each of the four directions correspond to an edge of the image. Example operations for computing a resize amount are described in reference to FIGS. 2B and 2C.

At 150, the seam carving application 622 may determine a starting pixel with a least amount of energy, for example, based on at least one of the activity maps. In some implementations, determining the starting pixel may include generating bias map based on the mask, generating an activity map, and/or multiplying the activity map with the bias map at each pixel to create a modified activity map. In some instances, the seam carving application 622 may search a bottom or other row of the modified activity map to determine a pixel with a least accumulated directional activity and set the determined pixel as the starting pixel. Example operations for determining a starting pixel are described in reference to FIG. 2C.

At 152, the seam carving application 622 may determine one or more paths from the starting pixel with fewer than a threshold number of interactions with the objects. For instance, the seam carving application 622 may determine a first path from a starting pixel with fewer than a threshold quantity of interactions with one or more of the objects determined above. Example operations for determining a path are also described in reference to FIGS. 1A and 2C.

In some implementations, at 154, the seam carving application 622 may remove the one or more paths from the image based on the resize amount for the first direction. For example, the seam carving application 622 may remove paths satisfying the constraint described at 152 until the directional resize amount is met. As noted above, if the seam carving application 622 is set to expand an image in a certain direction, it may add pixels at or adjacent to the path to expand the image.

In some implementations, at 156, the seam carving application 622 may rotate the image, for example, by 90 degrees. For instance, if the previous calculations were performed vertically from the top of an image to the bottom of the image (or otherwise), the seam carving application 622 may rotate the image, so that it can perform the operations (e.g., by iterating code) from a first side of the image to a second side of the image (e.g., from a top to a bottom of the image after the image is rotated). For instance, the seam carving application 622 may process the image from the second direction to determine one or more second paths (e.g., by returning to 146 or 150).

At 158, the seam carving application 622 may determine whether a threshold amount of rotation is satisfied, for example, if the image has been rotated 3, 4, or 8 times.

At 160, the seam carving application 622 may output the modified/resized image, for example by displaying the image on a graphical interface, transmitting the image to another device, communicating the image via an application programming interface to another process, application, or computer, or otherwise output the image. For instance, the seam carving application 622 may out put a full resolution (with removed or added pixels, as described herein) and/or color of the image for viewing or further processing (e.g., applying filters, etc.).

FIG. 2A-2D illustrates example detailed methods for resizing an image. For example, FIG. 2A illustrates an example method for generating a mask. At 202, the seam carving application 622 may receive an image. For example, the seam carving application 622 may source an RGB image from the operating system.

At 204, the seam carving application 622 may generate a feature map and, at 206, may carry the feature map forward for a subsequent operation. In some implementations, the seam carving application 622 may run the image through DeepLabV3 DCNN to generate, for example, a 513×513 map that identifies background pixels and pixels belonging to, for example, 1 of 19 classes of objects, although, it should be noted that other operations are possible and contemplated.

At 208, the seam carving application 622 may generate or use a foreground and/or background pixel map and, at 210, may carry the foreground and/or background pixel map forward for a subsequent operation. In some implementations, the seam carving application 622 may run the image through a saliency function (e.g., Apple's® or another operating system's built-in saliency function) to generate, for example, a 68×68 or other resolution map that identifies foreground and background pixels. In some implementations, the seam carving application 622 may use other operations, such as using neural networks to generate maps. The foreground/background pixel map may identify objects based on which pixels are foreground pixels.

At 212, the seam carving application 622 may scale the foreground and/or background pixel map and, at 214, carry it forward for further operations. For instance, the seam carving application 622 may scale the map, for example, to 513×513 or another resolution. For instance, the resolution of the maps or masks may be varied based on performance requirements of the computing device on which the operations are executed.

At 216, the seam carving application 622 may convert the image to grayscale and, at 218, carry the grayscale image forward for further operations. In some implementations, the seam carving application 622 may convert the image to unbiased grayscale, for example, where gray=0.33 red+0.34 green+0.33 blue, although other implementations are possible.

At 220, the seam carving application 622 may scale the grayscale image. In some implementations, the seam carving application 622 may scale the grayscale image, for example, to 513×513. In a similar way to the maps or masks, the image may be scaled based on processing requirements. The image may be scaled to be the same scale as the maps or masks, so that the pixels of each match. In some instances, the image's resolution may be scaled back up when output by removing/adding corresponding pixels to the full resolution image.

At 222, the seam carving application 622 may generate a map identifying one or more edge pixels and, at 224, carry the edge pixel map forward for further operations. In some implementations, the seam carving application 622 may apply, for example, a 5×5 diagonal Sobel kernel to generate a map that may identify, for instance, edge pixels with emphasis on diagonal edges over vertical and horizontal edges. An example edge map is illustrated in FIG. 5B.

At 226, the seam carving application 622 may combine the float valued maps from 206, 214, and 224 into a binary or float-valued mask, which it may carry forward at 228. For instance, the values of the feature map, foreground/background map, and/or edge pixel map may represent a set of probabilities which may be combined into a single probability map or mask. In some implementations, the seam carving application 622 may combine the float-valued maps into a binary mask by thresholding and OR'ing the maps. For example, a 1/true in the mask may indicate a foreground pixel.

FIG. 2B illustrates an example method for calculating an amount of resizing in one or more directions of an image. The operations of FIG. 2B, for instance, may be performed sequentially or in parallel with those of FIG. 2A.

At 230, the seam carving application 622 may receive the mask, such as the mask determined at 226, and, at 232, the seam carving application 622 may scrub small clusters from the mask. In some implementations, the seam carving application 622 may remove small clusters in the mask that are deemed noise or objects that are too small (e.g., below a threshold size, number of pixels, or activity). The seam carving application 622 may specify that an object be a certain size. The size of object may be defined, for example, based on an administrative setting indicating a threshold size in pixels, percent of the image, etc., at which an object may be removed from an image.

At 234, the seam carving application 622 may receive the image, such as the image from 202. In some instances, the seam carving application 622 may receive an already downscaled and/or grayscaled image, for example as generated above

At 236, the seam carving application 622 may downscale the image if needed. In some implementations, the seam carving application 622 may, if needed, downscale the RGB image to a defined or determined size or resolution based on a processing speed requirement, for example, so that the rest of the image will execute at a predetermined speed on the device to satisfy performance requirements.

At 238, the seam carving application 622 may scale the mask to match the image dimensions. In some implementations, the seam carving application 622 may scale the mask to match the image dimensions.

At 240, the seam carving application 622 may identify minimum vertical and/or horizontal space between the objects. In some implementations, the seam carving application 622 may analyze the mask to identify the minimum vertical and/or the minimum horizontal space between the objects. In some instances, these minimums may constrain the amount of resizing along the various dimensions (e.g., horizontal and vertical). The identified space may indicate how much space the seam carving application 622 can manipulate around the object.

At 242, the seam carving application 622 may convert the downscaled image to grayscale and/or use a grayscaled image already generated.

At 244, the seam carving application 622 may generate four directional activity maps. An activity map may indicate accumulated contrast or forward energy in one or more locations and/or directions. For example, a more textured region, path, or direction of the image would have a higher energy than a lower textured region of the image (e.g., so flatter or lower contrast regions are more likely to be resized).

In some implementations, the seam carving application 622 may use forward energy as the directional energy of the activity map, for instance, to determine which areas and/or directions of the image have higher activity or energy. For instance, the forward energy may indicate a change in energy indicating if the energy increases/decreases along a certain direction or path. For example, a difference or contrast between two or more pixels (e.g., each color, brightness, blackness, whiteness, etc., may be assigned a value) may be computed and summed along a direction for an image, for a row of pixels, or other portion of an image, mask, or map.

Some implementations for computing a forward energy are described in Rubinstein, Michael et al. “Improved seam carving for video retargeting.” SIGGRAPH 2008 (2008). Although, it should be noted that the seam carving application 622 improves over the operations of the Rubinstein reference using the operations described herein. For example, the seam carving application 622 may apply forward energy equations described in Rubinstein to the image rotated 0, 90, 180, and 270 degrees to the image, which may generate top-to-bottom, bottom-to-top, left-to-right, and right-to-left activity maps. It should be noted that that other implementations for determining contrast level or variation, activity, energy, or other variations in the image are contemplated and may be used for the activity maps described herein.

At 246, the seam carving application 622 may sum a row (e.g., a bottom row) of each activity map and, at 248, the seam carving application 622 may determine the ratios of the summed bottom rows. For instance, the four sums may represent directional activity levels accumulated across the image. The ratios of the sums may be used to guide the resizing amount along each of the four directions. For example, resizing may be performed approximately inversely proportional to the ratios so that regions/directions with high activity will be affected less than regions/directions with low activity or energy, as described above.

The ratios may represent the proportions between accumulated total energy for the different directions (e.g., top-to-bottom over left-to-right or over total energy). For instance, the ratios may be used to weight the directions thereby allowing the seam carving application 622 to determine the best direction(s) via which to resize the image. For example, based on the ratios, the seam carving application 622 may bias the amount of resizing in each direction, such as a certain direction may have a target to remove 30 seams.

At 250, the seam carving application 622 may determine resize amounts for a target aspect ratio. In some implementations, the seam carving application 622 may determine resize amounts (e.g., horizontally and vertically) to achieve a target aspect ratio, such as 1:1.

At 252, the seam carving application 622 may calculate an optimum amount of resizing in one or more directions, for example, based on the determined resize amounts for the target aspect ratio, the minimum vertical and/or horizontal space between objects, and/or the determined ratios of sums. In some implementations, the seam carving application 622 may use the ratios determined at 246, the minimums determined at 240, and/or the resize amounts determined at 250 to calculate an optimum achievable amount of resizing in each of the four (or another quantity) directions. The seam carving application 622 may combine these values arithmetically, by weighting them, or use them alternatively, depending on administrative setting. In some instances, the optimum achievable amounts may not necessarily perfectly achieve the aspect ratio (e.g., 1:1), although other implementations are possible.

FIG. 2C illustrates an example method for resizing an image along at least one direction, for example, using information generated in FIGS. 2A and/or 2B. In some implementations, at 254, the seam carving application 622 may rotate the image and mask so that their width is greater than their height (e.g., as illustrated in FIG. 3A the image may already be wider than it is tall). The seam carving application 622 may re-name/label the resize amounts to correspond to the correct sides of the image after the rotation, for example, to ensure that the order of subsequent operations is correct. For instance, the subsequent operations may incrementally resize the image toward the target aspect ratio. For example, when resizing a wide image into a 1:1 aspect ratio, the seam carving application 622 may subtract a width, add a height, subtract a width again, and then add to the height again.

In some implementations, at 256, the seam carving application 622 may generate a bias map. In some implementations, the seam carving application 622 may generate a bias map by multiplying the mask by a first factor and clip it by a second factor. For instance, the seam carving application 622 may multiply the mask by 1.8 and clip it by between 1.0 and 1.8 to create the bias map, although other values and implementations are possible and contemplated herein, for example, one or both of these factors may be generated based on the size or other attributes of the image.

In some implementations, the bias map may be binary (e.g., 0 or 1) although float values indicating probability that a pixel is properly classified are possible.

At 258, the seam carving application 622 may generate one or more activity maps. In some implementations, the seam carving application 622 may generate the activity map in the way described above in reference to 244 (or it may use a previously generated activity map). Depending on the implementation, the seam carving application 622 may generate an activity map for only the current direction or it may generate the activity map for each of the directions described above.

At 260, the seam carving application 622 may multiply the activity map by the bias map. In some implementations, the seam carving application 622 may modify (e.g., to create a modified activity map) the activity map by multiplying it at each pixel by the values of the bias map as the map is being generated, for example, from top to bottom. In some instances, this may be done for each direction (e.g., each direction of the activity maps). Although other implementations are possible, this multiplication step may increase activity of foreground pixels above natural activity of textures in the image. For example, an activity map or a modified activity map may be a float version of the bias map or mask with values corresponding to probabilities (e.g., of background or foreground/object).

At 262, the seam carving application 622 may determine a pixel with a least accumulated directional activity. In some implementations, the seam carving application 622 may search a bottom row (e.g., of pixels) of the activity map to find the pixel with the least accumulated directional activity. For instance, the activity map or modified activity map may represent an accumulated energy in a certain direction (e.g., from the top-to-bottom), and the seam carving application 622 may look at the accumulated energy in a bottom or other row and find a pixel with a least accumulated energy, which it may use as a starting point for a path.

At 264, the seam carving application 622 may determine a path of least energy from the determined pixel to an opposing edge/side (e.g., to a top row) of the image. In some implementations, the seam carving application 622 may start at the starting pixel from 262 and record a path of least energy (e.g., a “seam”) upwards until the top row (e.g., of pixels) is reached, although the seam may be determined in different directions.

In some instances, the path may begin from the starting pixel and extend to a next pixel with a least difference in energy or contrast from the starting pixel. For instance, a next pixel in the path may be determined based on it having a least contrast and being within a threshold distance from the previous pixel, for example, a threshold may indicate that a next pixel is one of the three next pixels touching the previous pixel, thereby resulting in a single pixel wide path. For instance, although disconnected pixels are possible, a connected path of pixels may be determined so that a single pixel wide path is drawn across the image and, when the path is removed (or pixels are added along the path), a width (or height, depending on processing direction) of the image is reduced by a single pixel across the entire image. It should also be noted that the path of pixels may be multiple pixels wide, so that when it is removed the width is reduced by the multiple pixels.

Although other implementations are possible, such as those described herein and elsewhere, the seam carving application 622 may use operations described in Avidan, S. and Ariel Shamir. “Seam carving for content-aware image resizing.” ACM SIGGRAPH 2007 papers (2007) for determining the path pixels. However, as noted above, the Avidan reference fails to take into consideration many of the operations described herein for improving seam carving.

At 266, the seam carving application 622 may determine a number of times that the path hits an object. In some implementations, the seam carving application 622 may record the number of times the path of least energy intersects an object (e.g., as determined above). For instance, the object may be represented by a value (e.g., of 1.8) in the bias map. The hits of the object may be determined, for example, based on the mask.

At 268, the seam carving application 622 may determine whether a threshold number of hits has been satisfied. For example, the seam carving application 622 may check if the path hits an object more times than one percent (or other defined or determined threshold) of the height of the image (e.g., more than one percent of the pixels correspond to pixels of the objects, a certain bias map value, or a certain activity map value).

At 270, responsive to the path having less than the threshold hits with objects, the seam carving application 622 may delete the path from the image and, in some instances, the bias map or modified activity map. Although this operation is described as removing paths, in some implementations, the seam carving application 622 may add pixels at the path, for example, as described in reference to 286 or 116. In some instances, the seam carving application 622 may also remove or add pixels to one or more of the maps or masks described herein so that they remain consistent with the image.

At 272, the seam carving application 622 may determine whether the resize amount has been met. For example, if the optimum achievable amount of resizing has been achieved for the current direction (e.g., as described above), the seam carving application 622 may exit the process and/or move to 279 in FIG. 2D.

At 274, the seam carving application 622 may select a new starting point, for example, if the resize amount has not been met. For instance, if the optimal or determined resize amount in a certain direction has not been met, the seam carving application 622 may select a new starting point along the same edge as the previous starting point (e.g., the same row, edge, or bottom row as the previous starting point). The new starting point may be adjacent to the previous starting point or a defined distance away and/or determined as described above. For example, the seam carving application 622 may return to the operation at 264 or 262 and proceed row-by-row (or column by column, pixel by pixel, and/or path by path) removing segments to the right or left of a previous removed/removable path. In some implementations, the seam carving application 622 may proceed row-by-row and memcopy the segments to the left of the path and memcopy the segments to the right of the path into a buffer.

In some implementations, as paths are determined or removed, the seam carving application 622 may repeat the process/remove paths a maximum quantity of times before finding a new path (e.g., a predefined distance away from the first or last removed path) or moving to 279. For instance, the process of 264-274 may be repeated a maximum of 20 times before moving to a new location of the image or rotating the image (e.g., where more paths may be added or removed or the resizing of the image may be stopped altogether).

At 276, if there are a threshold number of hits at 268, the seam carving application 622 may determine whether a threshold quantity of iterations has been satisfied. If too many iterations (e.g., 20 or another threshold) have been performed without finding a removable path (e.g., with fewer than a threshold number of hits), the seam carving application 622 may exit the process, proceed to 279 in FIG. 2D or return to 258 to re-compute the activity map, for example, if no path is found. In some instances, the number of iterations for purposes of the calculation at 276 may be reset each time a removable path is met or may be accumulated over the entire direction for the image.

At 278, the seam carving application 622 may select a new starting pixel with a least accumulated activity. For instance, if the path hits an object too many times, the seam carving application 622 may select a new starting point on the bottom row that is a predefined distance away from the previous starting point and/or has a lowest accumulated activity(e.g., as at step 262). In some implementations, if a quantity (e.g., a threshold such as 20 times) of paths fail or stop early, the seam carving application 622 may move to a new area or direction (e.g., by rotating the image or processing direction) of the image to add/remove paths (e.g., such as described in FIG. 2D). For instance, if the path hits an object too many times, the seam carving application 622 may select a new starting point that is a defined or determined distance away from the previous starting point and/or has a lowest accumulated activity and/or is on a new edge of the image.

FIG. 2D illustrates an example method for adjusting operations to resize an image in multiple directions.

At 279, the seam carving application 622 may determine and record a difference between the achieved and optimum resize amounts and, at 280, the seam carving application 622 may add the difference to a remainder or remaining resize amounts in one or more directions. For example, if it is not possible to remove a sufficient amount of space in a direction, the seam carving application 622 may carry the remainder forward to other directions. For instance, if the target (e.g., the optimal, or determined amount) amount to resize a direction was determined to be 30 seams, but only 25 are removed, the seam carving application 622 may add or remove the difference (e.g., 5 seams) to the resize amount (e.g., for a different direction) in a subsequent pass, such as after rotating (e.g., 90 or 180 degrees) and/or after reducing constraints in 294, as described below.

For example, the seam carving application 622 may determine a resize amount (e.g., a proportional resize amount) by identifying the space between the objects based on the mask may include identifying a minimum vertical space between the objects and identifying a minimum horizontal space between the objects and/or using a directional activity map or activity level ratios, as described above.

The seam carving application 622 may determine that a first resize amount has not been met during resizing of the image in the first direction, record a difference between the achieved resize amount in the first direction and a first resize amount (e.g., a target, optimum, or other determined amount), and determine a remainder based on the difference. The remainder may indicate a positive or negative amount of resize and, in some instances, may be tied to a certain direction. For instance, if the remainder from the first direction is 5 pixels/paths short, then the image (e.g., the target resize amount) may be expanded by a positive 5 pixels in a second direction, which is 90 degrees of rotation from the first direction. If a second resize amount in the second direction is not met, the remainder may be carried forward to a third direction, and so forth.

At 282, the seam carving application 622 may determine whether a width is to be decreased in the current direction and, in response to a positive determination, proceed to 288. For instance, this may be based on whether the remainder is positive or negative, an optimum or target resize amount, a target aspect ratio, etc.

At 284, the seam carving application 622 may determine whether the width is to be increased in the current direction and, at 286, the seam carving application 622 may insert one or more new pixels at a path location row by row. For example, the seam carving application 622 may proceed row-by-row inserting a new pixel at or adjacent to the path location. In some implementations, a value, brightness, or color of each new pixel may be calculated by quadratic or other type of interpolation of the pixels in the path, although other implementations are possible. In some instances, the region upon which the new pixel may be calculated may be plus or minus 3 pixels, although other implementations are possible.

At 288, the seam carving application 622 may rotate the image and the bias map, for example, by 90 degrees, 180 degrees, or another amount. In some implementations, the seam carving application 622 may intelligently rotate the image based on whether the image has been reduced by the resize amount for a given direction. For instance, the seam carving application 622 may determine that the image has been reduced by the optimum achievable amount of resizing in a horizontal direction and may rotate the image to be vertical to add or remove paths based on the target size or aspect ratio. For instance, if a width is to be decreased, the seam carving application 622 may rotate the image and/or processing direction so that when seams are removed, they are removed in the correct direction.

In some implementations, the operations of the seam carving application 622 may operate in a top-to-bottom or other direction, so the seam carving application 622 may rotate the image and use the same or similar operations from the new direction of the image. For example, the seam carving application 622 may perform top-to-bottom operations on a rotated image in order to perform the operations from a new direction of the image.

At 290, the seam carving application 622 may determine whether the image has been rotated a threshold quantity of times. For example, the seam carving application 622 may determine whether the image has been resized/processed in 1 direction, 2 directions, 4 directions, or 8 directions. In some instances, the seam carving application 622 may be programmed to process and resize images (e.g., by adding or subtracting paths) from each of four directions matching each of the four sides of the image. The seam carving application 622 may, if the threshold number of rotations hasn't been met, return to the operation at 258 or 264 for a next direction.

An example result image based on a 1 direction processing is illustrated in FIG. 4B, and example result image based on an 8-direction processing is illustrated in FIG. 4C. As illustrated, the 8-pass result may resize the image by different amounts or additionally than the 1-pass result, which may result in the image having more seams added or removed in certain directions. In some implementations, while the objects in the image of FIG. 4C, may be slightly more distorted (e.g., because the more interactions are allowed for any given path of pixels), the image has been resized differently. For instance, when resizing the image 401a from only a single direction, the resulting image 401b is off center. When distributing the resizing amounts from multiple directions, the composition or centering of the objects in the image may remain more constant.

At 292, the seam carving application 622 may determine whether the target ratio has been met. The target aspect ratio may correspond to a target aspect ratio defined by a user, an application, or by the optimum resize amounts. In some implementations, the seam carving application 622 may determine whether the target aspect ratio has been met (e.g., 1:1, 1:2, 16:9, 2:1, etc.). If the target aspect ratio for the image has been met, the seam carving application 622 may proceed to 296.

If the target ratio has not been met, in some implementations, at 294, the seam carving application 622 may reduce constraints and repeat operations for the current direction, for example, by returning to 258. For instance, after a pass has been made to resize the image from each of the four directions, the seam carving application 622 may rotate through one or more additional directions, for example, the operations may be performed in an additional four directions or, rather, a second time/pass in each of the four directions. For the second pass in a certain direction, the seam carving application 622 may remove some of the constraints, for example, by interpreting one or more of the masks or maps more loosely. In another example of reducing constraints, the seam carving application 622 may allow a path to hit more pixels, for example, at 268. Although resizing in an initial four directions and then an additional four directions is described herein, it should be noted that any number of initial directions (e.g., 1 or 2, etc.) or additional directions (1, 2, 8, etc.) may be used.

For example, after determining that the target aspect ratio has not been achieved, the seam carving application 622 may reduce a processing requirement for adding pixels or removing pixels from the image. In some instances, the seam carving application 622 may rotate the image or process the image in a different direction, although the seam carving application 622 may simply re-process the image from a current direction/orientation. The seam carving application 622 may add or remove paths of pixels in one or more directions, as described above.

At 296, the seam carving application 622 may rotate the resized/modified image to the original orientation, for example, at which the image was received.

At 298, the seam carving application 622 may output the modified image, for example, at the target aspect ratio.

FIG. 3A illustrates an example image 301a that may be resized using the technology described herein. For instance, FIG. 3A illustrates an example path 302 that may be removed to make the image 301a narrower. It should be noted that, depending on the implementation, a path may be strait or curved.

FIG. 3B illustrates the example image 301b that has been resized horizontally and rotated. As illustrated, the image 301a may be rotated 90 degrees and processed using the operations described above. For instance, the seam carving application 622 may determine a path 304 in the image 301b. In some implementations, the seam carving application 622 may add pixels along one or more paths, such as the illustrated path 304. Although the example image 301b may be rotated in two directions, as illustrated, the image 301b may be rotated in additional or fewer directions.

FIG. 3C illustrates an example result 301c image that may be generated by narrowing the image 301a as in FIG. 3A and widening (or making taller) the image 301b as in FIG. 3B.

FIG. 4A illustrates another example image 401a that may be resized using the technology described herein. For instance, the image 401a may be input into the seam carving application 622. As illustrated, the input image 401a is wider than it is tall. The target aspect ratio may be a square.

FIG. 4B illustrates an example resized image 401b where the seam carving application 622 has resized the image 401a from a single direction. For instance, when resizing the image 401a from only a single direction, the resulting image 401b is off center.

FIG. 4C illustrates an example resized image where the seam carving application 622 has resized the image from 8 directions (e.g., 2 iterations from each side of the image). When distributing the resizing amounts from multiple directions, such as in the 8-pass result, the composition or centering of the objects in the image 401c may remain more constant.

In some implementations, objects in the image 401c of FIG. 4C, may be slightly more distorted (e.g., because the more interactions are allowed for any given path of pixels), the image has been resized differently.

FIG. 5A illustrates an example edge map 502, which may correspond to an edge map or mask described above. For instance, the pixels of the edge map may indicate edge(s) of object(s) in an image, such as the image 401a in FIG. 4A, and may correspond to the edge map(s) or mask(s) described in reference to the operations above. An edge map may be used by the seam carving application 622 to reduce jagged or disjoined lines, although other implementations are possible.

FIG. 5B illustrates an example object map 504, which may correspond to an object map or mask described above. For instance, the pixels in the object map may represent detected object(s) in an image, such as the image 401a in FIG. 4A, and may correspond to the object map(s) or mask(s) described in reference to the operations above. An object mask may help prevent distortions of objects, as described above, although other implementations are possible.

FIG. 5C illustrates an example combined map 506 or mask, which may be a combination of an edge map and an object map or mask, such as those illustrated in FIGS. 5A and 5B and described above.

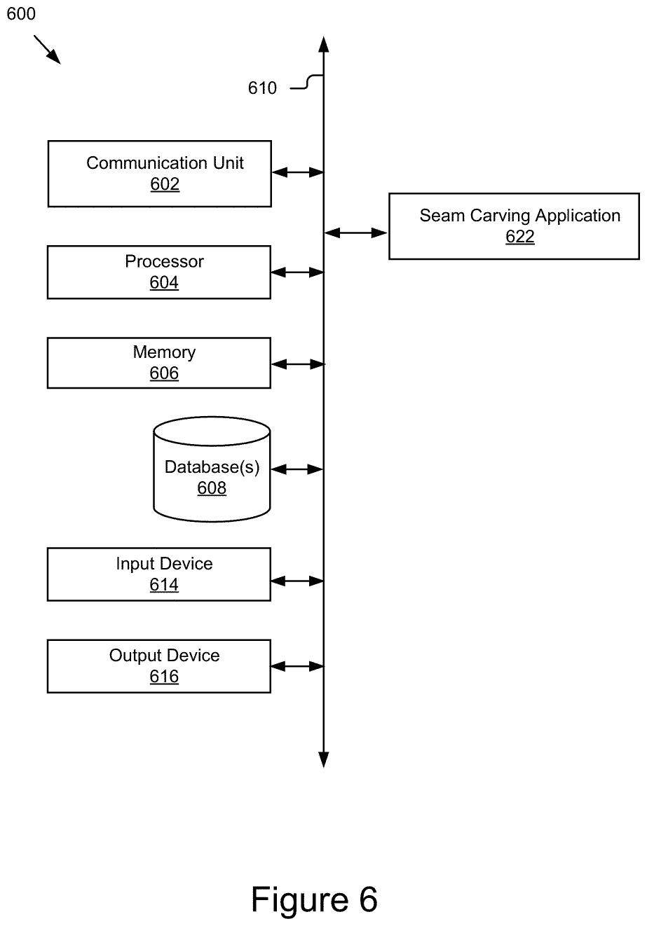

FIG. 6 illustrates a computing device 600 that can implement the operations described above, for example, the computing device may execute the seam carving application 622. As depicted, the computing device 600 may include a communication unit 602, a processor 604, a memory 606, database(s) 608, an input device 614, an output device 616, and the seam carving application 622, which may be communicatively coupled by a communication bus 610. The computing device 600 depicted in FIG. 6 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing device 600 may include various operating systems, sensors, additional processors, and other physical configurations. Although, for purposes of clarity, FIG. 6 only shows a single communication unit 602, processor 604, memory 606, etc. It should be understood that the computing device 600 may include a plurality of one or more of these components.

The processor 604 may execute software instructions by performing various input, logical, and/or mathematical operations. The processor 604 may have various computing architectures to method data signals including, for example, a complex instruction set computer (CISC) architecture, a reduced instruction set computer (RISC) architecture, and/or an architecture implementing a combination of instruction sets. The processor 604 may be physical and/or virtual and may include a single core or plurality of processing units and/or cores. In some embodiments, the processor 604 may be capable of generating and providing electronic display signals to a display device, supporting the display of images, capturing and transmitting images, performing complex tasks including various types of feature extraction, and sampling, etc. In some embodiments, the processor 604 may be coupled to the memory 606 via the bus 610 to access data and instructions therefrom and store data therein. The bus 610 may couple the processor 604 to the other components of the computing device 600 including, for example, the communication unit 602, the memory 606, the input device 614, the output device 616, and the database(s) 608.

The memory 606 may store and provide access to data to the other components of the computing device 600. The memory 606 may be included in a single computing device or a plurality of computing devices. In some embodiments, the memory 606 may store instructions and/or data that may be executed by the processor 604. For example, the memory 606 may store an instance of the seam carving application 622 and its respective components, depending on the configuration. The memory 606 is also capable of storing other instructions and data, including, for example, an operating system, hardware drivers, other software applications, databases, etc. The memory 606 may be coupled to the bus 610 for communication with the processor 604 and the other components of the computing device 600.

The memory 606 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 604. In some embodiments, the memory 606 may include one or more of volatile memory and non-volatile memory (e.g., RAM, ROM, hard disk, optical disk, etc.). It should be understood that the memory 606 may be a single device or may include multiple types of devices and configurations.

The bus 610 may include a communication bus for transferring data between components of a computing device or between computing devices, a network bus system including a network (e.g., the Internet) or portions thereof, a processor mesh, a combination thereof, etc. Various components operating on the computing device 600 (operating systems, device drivers, etc.) may cooperate and communicate via a communication mechanism included in or implemented in association with the bus 610. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 602 may include one or more interface devices (I/F) for wired and wireless connectivity among the components of a system. For example, the communication unit 602 may include various types known connectivity and interface options. The communication unit 602 may be coupled to the other components of the computing device 600 via the bus 610. The communication unit 602 may be electronically communicatively coupled to an external network (e.g., wiredly, wirelessly, etc.). In some embodiments, the communication unit 602 may link the processor 604 to the network, which may in turn be coupled to other processing systems. The communication unit 602 may provide other connections to the network and to other computing systems using various standard communication protocols.

The input device 614 may include any device for inputting information into the computing device 600. In some embodiments, the input device 614 may include one or more peripheral devices. For example, the input device 614 may include a sensor, a keyboard (e.g., a virtual keyboard), a pointing device (e.g., a virtual mouse device), a microphone for receiving user input via speech, an image/video capture device (e.g., camera), a touch-screen display integrated with the output device 616, etc.

The output device 616 may be any device capable of outputting information from the computing device 600. The output device 616 may include one or more of a speaker, a display (LCD, OLED, etc.), a haptic device, a touch-screen display, a light indicator, etc. In some embodiments, the output device 616 may be a display that can display electronic content (e.g., images, videos, etc.) with different representation effects (e.g., rewind, overlaid animation, etc.). In some embodiments, the computing device 600 may include a graphics adapter (not shown) for rendering and outputting the electronic content for presentation on the output device 616. The graphics adapter (not shown) may be a separate processing device including a separate processor and memory (not shown) or may be integrated with the processor 604 and the memory 606.

The database(s) 608 may be data store(s) for storing and providing access to data. The data stored by the database(s) 608 may be organized and queried using any type of data stored in the database(s) 608 (e.g., template ID, entity ID, template name, category tag, etc.). The database(s) 608 may include file systems, databases, data tables, documents, or other organized collections of data. Examples of the types of data stored in the database(s) 608 may include user data, template data, content item data, etc.

The database(s) 608 may be included in the computing device 600 or in another computing system and/or storage system distinct from but coupled to or accessible by the computing device 600. The database(s) 608 may include one or more non-transitory computer-readable mediums for storing the data. In some embodiments, the database(s) 608 may be incorporated with the memory 606 or may be distinct therefrom. In some embodiments, the database(s) 608 may store data associated with a database management system (DBMS) operable on the computing device 600. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The components 622, 602, 604, 606, 608, 614, and/or 616, may be communicatively coupled by the bus 610 and/or the processor 604 to one another and/or to other components of a computing system. As discussed elsewhere herein, the seam carving application 622 may include computer logic (e.g., software logic, hardware logic, etc.) executable by the processor 604 to provide functionalities described herein.

It should be understood that the computing device 600 illustrated in FIG. 6 is representative of example systems and that a variety of different system environments and configurations are contemplated and are within the scope of the present disclosure. For example, various acts and/or functionality may be moved from a server to a client, or vice versa, data may be consolidated into a single data store or further segmented into additional data stores, and some embodiments may include additional or fewer computing devices, services, and/or networks, and may implement various functionality client or server-side. Further, various entities of the system may be integrated into a single computing device or system or divided into additional computing devices or systems, etc.

Methods are described herein; however, it should be understood that the methods are provided by way of example, and that variations and combinations of these methods, as well as other methods, are contemplated. For example, in some embodiments, at least a portion of one or more of the methods represent various elements of one or more larger methods and may be concatenated or various steps of these methods may be combined to produce other methods which are encompassed by the present disclosure. Additionally, it should be understood that various operations in the methods may in some cases be iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various embodiments are described as having particular hardware, software, and user interfaces. However, the present disclosure applies to any type of computing device that can receive data and commands, and to any peripheral devices providing services.

In some instances, various embodiments may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices can be coupled to the system either directly or through intervening I/O controllers. The data processing system may include an apparatus that may be specifically constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects may not be mandatory or significant, and the mechanisms that implement the specification or its features may have different names, divisions and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to embodiment in any specific programming language, or for any specific operating system or environment. Accordingly, the disclosure is intended to be illustrative, but not limiting, of the scope of the subject matter set forth in the following claims.

What is claimed is:

1. A method comprising:
receiving, by one or more processors, a digital image file of an image;
computing, by the one or more processors, one or more masks identifying one or more objects in the image;
determining, by the one or more processors, a first path of pixels extending between a first edge of the image and a second edge of the image using the one or more masks, the first edge opposing the second edge;
removing, by the one or more processors, the first path of pixels from the image to generate an edited image; and
outputting, by the one or more processors, the edited image, the edited image having a different aspect ratio than the received image.

2. The method of claim 1, wherein determining the first path of pixels includes:
determining the first path of pixels from a first starting pixel on the first edge, the first path of pixels having fewer than a threshold quantity of interactions with the one or more objects in the image based on the one or more masks.

3. The method of claim 2, further comprising:
determining, by the one or more processors, a quantity of interactions of the first path with the one or more objects based on each time the first path of pixels intersects with the one or more objects identified by the one or more masks, the threshold quantity of interactions being a percentage of a distance between the first edge and the second edge in pixels.

4. The method of claim 2, further comprising:
determining, by the one or more processors, a second starting pixel on the first edge for a second path of pixels;
determining, by the one or more processors, a quantity of interactions of the second path with the one or more objects; and
in response to determining that the quantity of interactions of the second path satisfy the threshold quantity of interactions with the one or more objects, stopping determination of the second path of pixels and determining the first starting pixel for the first path of pixels.

5. The method of claim 1, further comprising:
determining, by one or more processors, a first starting pixel on the first edge based on the first starting pixel having a least accumulated directional activity, the first starting pixel being a first pixel on the first path of pixels.

6. The method of claim 1, further comprising:
determining, by the one or more processors, a second path of pixels between a third edge of the image and a fourth edge of the image using the one or more masks, the third edge opposing the fourth edge, the third edge being perpendicular to the first edge; and
adding, by the one or more processors, pixels along the second path.

7. The method of claim 6, further comprising:
removing, by one or more processors, the one or more first paths of pixels extending between the first edge and the second edge and adding the one or more second paths of pixels extending between the third edge and the fourth edge until a target aspect ratio is achieved, the one or more first paths including the first path, the one or more second paths including the second path.

8. The method of claim 1, further comprising:
determining, by the one or more processors, a first resize amount along a first direction based on one or more activity maps, the first direction extending between a third edge of the image and a fourth edge of the image, the third edge opposing and parallel with the fourth edge, the third edge being perpendicular to the first edge, the first resize amount reducing a quantity of pixels of the image along the first direction; and
determining, by the one or more processors, a second resize amount along a second direction based on the one or more activity maps, the second direction extending between the first edge of the image and the second edge of the image, the second resize amount increasing a quantity of pixels of the image along the second direction.

9. The method of claim 8, further comprising:
computing, by the one or more processors, a directional activity map in each of four directions for the image, the four directions including the first direction from the third edge to the fourth edge, the second direction from the first edge to the second edge, a third direction from the fourth edge to the third edge, and a fourth direction from the second edge to the first edge, the one or more activity maps including the directional activity maps in the four directions;
determining, by the one or more processors, a directional activity level across the image for each of the four directions; and
determining, by the one or more processors, a proportion of the first resize amount to the second resize amount based on ratios of the directional activity levels.

10. The method of claim 8, further comprising:
determining, by the one or more processors, that the first resize amount has not been met during resizing of the image in the first direction;
recording, by the one or more processors, a difference between an achieved resize amount in the first direction and the first resize amount; and
determining, by the one or more processors, a remainder based on the difference between the achieved resize amount in the first direction.

11. The method of claim 10, further comprising:
adjusting, by the one or more processors, the second resize amount based on the remainder so that additional pixels are added in the second direction.

12. The method of claim 10, further comprising:
adjusting, by the one or more processors, a third resize amount based on the remainder so that additional pixels are removed in a third direction, the third direction opposing and parallel with the first direction.

13. The method of claim 1, further comprising:
setting, by the one or more processors, the image to a first orientation in which a width of the image is greater than a height of the image, the first edge of the image being located at top of the image in the first orientation;
removing, by the one or more processors, the first path of pixels from the image;
rotating, by the one or more processors, the image ninety degrees to a second orientation;
adding, by the one or more processors, a second path of pixels to the image, the second path of pixels extending between a third edge of the image and a fourth edge of the image, the third edge opposing the fourth edge, the third edge being perpendicular to the first edge;
rotating, by the one or more processors, the image ninety degrees to a third orientation;
removing, by the one or more processors, a third path of pixels from the image, the third path of pixels extending between the second edge of the image and the first edge of the image;
rotating, by the one or more processors, the image ninety degrees to a fourth orientation; and
adding, by the one or more processors, a fourth path of pixels to the image, the fourth path of pixels extending between the fourth edge of the image and the third edge of the image.

14. The method of claim 13, further comprising:
determining, by one or more processors, that a target aspect ratio has not been achieved;
reducing, by one or more processors, a processing requirement for adding pixels to the image or removing pixels from the image based on the determination that the target aspect ratio has not been achieved;
rotating, by one or more processors, the image at least once to at least one of the first orientation and the third orientation;
removing, by one or more processors, a fifth path of pixels from the image; and
setting, by one or more processors, the image to an original orientation in which the image was received.

15. The method of claim 14, further comprising:
rotating, by one or more processors, the image at least once to at least one of the second orientation and the fourth orientation; and
adding, by one or more processors, a sixth path of pixels to the image.

16. The method of claim 1, wherein computing the one or more masks includes:
generating a binary mask using a feature map and a background-foreground pixel map.

17. The method of claim 1, further comprising:
removing, by the one or more processors, clusters of pixels from the one or more masks based on the clusters having fewer than a defined quantity of pixels.

18. The method of claim 1, wherein:
a starting pixel of the first path of pixels is located at the first edge of the image, and
the starting pixel of the first path of pixels is not located at a corner of the image.

19. The method of claim 18, wherein determining the starting pixel includes:
generating a bias map based on the one or more masks;
generating an activity map;
multiplying the activity map with the bias map at each pixel to create a modified activity map;
searching a row of the modified activity map to determine a pixel with a least accumulated directional activity; and
setting the determined pixel as the starting pixel.

20. A system comprising:
one or more processors; and
a non-transitory computer readable memory storing instructions that, when executed by the one or more processors, cause the system to:
receive a digital image file of an image;
compute one or more masks identifying one or more objects in the image;
determine a first path of pixels extending between a first edge of the image and a second edge of the image using the one or more masks, the first edge opposing the second edge;
remove the first path of pixels from the image to generate an edited image; and
output the edited image, the edited image having a different aspect ratio than the received image.

21. A system comprising:
means for receiving a digital image file of an image;
means for determining a target aspect ratio for the image;
means for computing one or more masks identifying one or more objects in the image;
means for determining a first path of pixels extending between a first edge of the image and a second edge of the image using the one or more masks, the first edge opposing the second edge;
means for removing the first path of pixels from the image to generate an edited image; and
means for outputting the edited image, the edited image having a different aspect ratio than the received image.
